(19) United States
(12) Patent Application Publication
(10) Pub. No.: US 2020/0025683 A1
(43) Pub. Date: Jan. 23, 2020

(54) Method and sensor array for identifying an analyte

(71) Applicant: Universität Heidelberg, 69117 Heidelberg (DE)

(72) Inventors: Uwe Bunz, Heidelberg (DE); Kai Seehafer, Heidelberg (DE); Jinsong Han, Nanjing (CN); Markus Bender, Heidelberg (DE)

(21) Appl. No.: 16/335,640

(22) PCT Filed: Sep. 21, 2017
(86) PCT No.: PCT/EP2017/073949

§ 371 Date: Mar. 21, 2019

(30) Foreign Application Priority Data
Sep. 21, 2016 (GB) 1 616 038.4

(51) Int. Cl. G01N 21/64; G01N 21/78; C08G 61/02; C08G 61/12

(52) U.S. Cl. CPC G01N 21/6428; G01N 21/78; G01N 2021/7786; C08G 61/122; G01N 2021/6432; C08G 61/02

(57) ABSTRACT

A method and sensor array for identification of an analyte is disclosed. The method comprises preparing a plurality of solutions at a plurality of pH values of at least one fluorescent poly(para-phenyleneethynylene) and its complex(es), exposing the complex analyte to the plurality of the solutions and measuring the fluorescence intensity of the exposed complex analyte. The fluorescence intensity is compared with a library and the complex analyte identified from the comparison.

### CROSS-REFERENCE TO RELATED APPLICATIONS

This application claims benefit to and priority of UK Patent Application No. 1616038.4 filed on 21 Sep. 2016 and is a national phase entry of international patent application No. PCT/EP2017/073949 filed on 21 Sep. 2017 entitled “Method and Sensor Array for identifying an analyte”.

### BACKGROUND OF THE INVENTION

Discrimination and identification of complex analytes such as, but not limited to, fruit juices, alcoholic beverages, pharmaceutical preparations, and illegal drugs is an important and interesting topic.

For example, falsified, stretched, filled or faked drugs are a serious health policy problem that not only affects countries in the third world. Counterfeit antimalarials, antibiotics, painkillers, life-style drugs, HIV drugs etc. are all known. Such counterfeit drugs can cause drug-resistant bacterial and microbial strains to develop and spread. As a result, quality control, identification and fingerprinting of the active compounds in drugs, but also of the whole of the processed drug formulation (tablet, drops, capsules, suppositories) is an important task.

Similarly, quality control of food and other complex analytes is an important task. Many different types of analytical methods have been exploited for these tasks, including mass spectrometry, electrochemical tongues and noses, as well as biological methods (antibodies, genetics).

One method know in the art is the use of chemo-optical tongues. These chemo-optical tongues can indicate the spoiling of fish, fingerprint coffees, whiskeys, beers, soft drinks, red wines and white wines. The chemo-optical tongues react by color change or fluorescence intensity modulation. These chemo-optical tongues are comprised of sensor arrays of different chromophores or fluorophores or receptors that are bound to indicators or quenchers that are replaced by the analytes. The action principle of the chemo-optical tongues is different from that of classic sensors but also of that of instrumental analytical methods. In Askim, J. R.; Mahmoudi, M.; Suslick K. S. Optical sensor arrays for chemical sensing: the optoelectronical nose. Chem. Soc. Rev. 2013, 42, 8649-8682, Suslick described some of the features that are presumably necessary to achieve successful discrimination for complex analytes and stressed that “ . . . in general, an optimal sensor array for general sensing purposes will incorporate as much chemical diversity as possible . . . ”. This guided the development of colorimetric arrays, in which a wide variety of different colorimetric indicator molecules are employed to identify analytes. Suslick's printed libraries typically consist of 16-36 elements for successful identification of different classes of analytes.

A second accepted tenet of these chemo-optical tongues was formulated by Anslyn, and is a weakened variation of the lock and key-principle of Fischer as nicely shown in FIG. 1 of Ebeler, S. E. Analytical chemistry: Unlocking the secrets of wine flavor. Food Rev. Int. 2001, 17, 45-64. In this picture, molecular keys fit into many locks with a varying degree of fit.

Several of such partially fitting receptors identify and discriminate groups of analytes by the unique signal patterns of the sum of the sensor elements. Here the most practical approach is to offer small libraries of receptors that are “filled” with dyes to be replaced by the analytes with different efficiency.

These prior art approaches stress that cross-reactivity, structural differentiation and structural variation of the sensor elements are important, as expressed by the wish to obtain high dimensionality sensor arrays that differentiate a broad variety of similar, but complex analytes, such as soft drinks, coffees, beers, whiskeys, etc.

Both described prior art approaches, i.e. the weakened lock and key principle but also the chemical diversity of the sensors are sufficient principles to guide the production of useful sensor arrays. These prior art approaches generate an arbitrary and large number of working tongues and sensor elements, but neither predicts or defines the minimum structural variation in sensor elements necessary to discriminate complex analytes.

### SUMMARY OF THE INVENTION

An alternative approach is presented in this document. An array of charged fluorescent polymers in water at two different pH values is used as a four-element sensor, which acts as an efficient chemical “tongue”. The sensor is able to discern different types of non-steroidal anti-inflammatory drugs (NSAID) and is also able to discriminate between different brands of ibuprofen and aspirin. The sensor could be formed from a microtitre plate, a microwell plate or a microfluidic array.

It has already been shown that different versions (including conjugated polymer-gold nanoparticle complexes (Bunz, U. H. F.; Rotello, V. M. Gold Nanoparticle-Fluorophore Complexes: Sensitive and Discerning “Noses” for Biosystems Sensing. Angew. Chem. Int. Ed. 2010, 49, 3268-3279), conjugated polymer-green fluorescent protein complexes (Rana, S.; Elci, S. G.; Mout, R.; Singla, A. K.; Yazdani, M.; Bender, M.; Bajaj, A.; Saha, K.; Bunz, U. H. F.; Jirik, F. R.; Rotello, V. M. Ratiometric Array of Conjugated Polymers-Fluorescent Protein Provides a Robust Mammalian Cell Sensor. J. Am. Chem. Soc. 2016, 138, 4522-4529), and conjugated polymer-conjugated polymer complexes (Han, J.; Bender, M.; Seehafer, K.; Bunz, U. H. Identification of White Wines by using Two Oppositely Charged Poly(p-phenyleneethynylene)s Individually and in Complex. Angew. Chem. Int. Ed. 2016, 55, 7689-7692; Han, J. S.; Bender, M.; Hahn, S.; Seehafer, K.; Bunz, U. H. F., Polyelectrolyte Complexes Formed from Conjugated Polymers: Array-Based Sensing of Organic Acids. Chem. Eur. J. 2016, 22, 3230-3233; and Han, J. S.; H, W. B.; Bender, M.; Seehafer, K.; Bunz, U. H. F. Water-Soluble Poly(p-aryleneethynylene)s: A Sensor Array Discriminates Aromatic Carboxylic Acids. ACS Appl. Mater. Interfaces 2016, 8, 20415-20421)) of this concept successfully discriminated anions, white wines, proteins, cells, cancer states in mammalian cells etc. This document demonstrates the discrimination of eleven nonsteroidal anti-inflammatory drugs (NSAIDs, as shown in FIG. 1), red wines, green, black and oolong teas and fruit juices. These complex analytes are sufficiently narrow in scope, yet have significant differences.

It would also be possible to use the sensor for identifying other dissolved complex powder analytes.

In a preferred embodiment, the present invention is a method for the identification of an analyte using a sensor array using at least one highly fluorescent, water-soluble polymer under different conditions is disclosed, as well as a sensor array. The analytes identified include complex analytes, such as pharmaceutical preparations and liquids, such as wine and fruit juice but also simple analytes, such as carboxylic acids.

### BRIEF DESCRIPTION OF THE DRAWINGS

FIG. 1 shows structure and pKa value of the NSAIDs.

FIG. 2A shows water solubility of NSAIDs D1-D11 (6 mM) at different pH values.

FIG. 2B shows structures of positively charged P1 and negatively charged P2, used for analgesics sensing (φ=quantum yield).

FIG. 2C shows final selected four sensing factors by using single P1 and its electrostatic complex C (P1+P2).

FIG. 3A shows the synthesis of P2.

FIG. 3B shows the synthesis of P4.

FIG. 3C shows the synthesis of P9.

FIG. 4A shows a fluorescence response pattern obtained with an array of P1, C1-2 (each at pH 10 and 13, buffered) treated with D1-D11.

FIG. 4B shows a 2D canonical score plot obtained with an array of P1, C1-2 (each at pH 10 and 13, buffered) treated with analgesics D1-D11 (6 mM) and D4, D7 and D9 (from 30 to 1.8 mM). Each point represents the response pattern for a single concentration of analgesics to the array.

FIG. 5A shows the concentration dependencies of D4, D7 and D9 in an LDA plot.

FIG. 5B shows the concentration dependencies of D4, D7 and D9 together with the remaining NSAIDs.

FIG. 6A shows the fluorescence response pattern (I-I₀/I₀) obtained by P1 (500 nM, at pH 10 and 13, buffered) and complex C1-2 (P1-P2 at 500 nM-250 nM, at pH 10 and 13, buffered) treated with NSAIDs D2 (aspirin, 6 mM, control) and D8 (ibuprofen, 6 mM, control) and commercial available OTC tablet aspirin (ASS1-ASS5, 6 mM), ibuprofen (IBU1-IBU5, 6 mM).

FIG. 6B shows a 2D canonical score plot for the first two factors of simplified fluorescence response patterns obtained with an array of P1, C1-2 (each at pH 10 and 13, buffered) with 95% confidence ellipses. Each point represents the response pattern for a single analgesic to the sensor array.

FIG. 7A shows a 2D canonical score plot.

FIG. 7B shows a 3D canonical score plot obtained with an array of P1, C1-2 (each at pH 10 and 13, buffered) treated with NSAIDs D1-D11 and commercially available OTC tablet aspirin (ASS1-ASS5), ibuprofen (IBU1-IBU5).

FIG. 8A shows the results of a systematic evaluation and selection of the successful tongue elements of the sensor array for the juice sensing.

FIG. 8B shows the chemical structures and quantum yields (ϕ) of P1 and P2.

FIGS. 9A-9D show a first fluorescence response pattern combined with LDA of all of the fruit juices.

FIGS. 10A-10D show a second fluorescence response pattern combined with LDA of all of the fruit juices.

FIGS. 11A-11C combines the response results from all juices after LDA.

FIGS. 12A-12C show the fluorescence response patterns of the self-made juices compared to commercial juices (black currant, green grapes, red grapes) and mixtures of red and green grape juices.

FIGS. 13A-13C show the response pattern for three different types of teas.

FIGS. 14A-14C show the PPEs 1-3 used for the preparation for complexes with C8.

FIG. 15 illustrates the structure of C8.

FIG. 16 shows the PPEs for the discrimination of red wines.

FIG. 17 shows a microwell plate, similar to those used in this application as the sensor array.

### DETAILED DESCRIPTION OF THE INVENTION

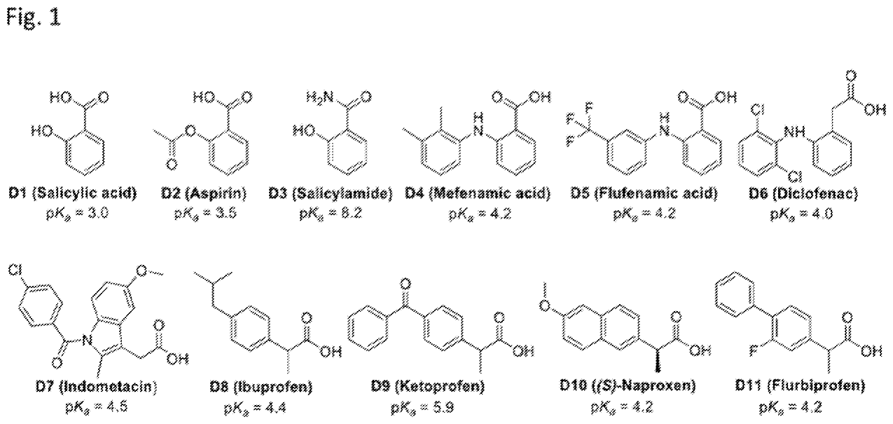

FIG. 1 shows the structure of eleven different types of NSAIDs chosen as a test bed in a first aspect of the concept. The structural similarity of the different NSAIDs suggests their separation into four groups, viz. salicylates, fenamic acids, profens and arylacetic acids.

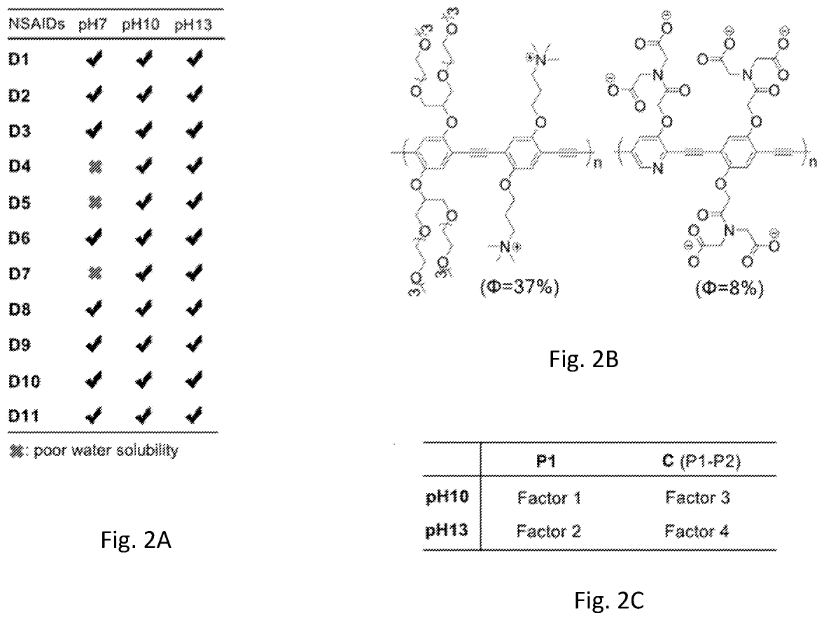

FIG. 2A shows the water solubility of the NSAIDs at 6 mM concentration at different pH values and the selected four-member array.

It is known that a sensor comprising poly(para-aryleneethynylene)s (PAE) and their polyelectrolyte complexes discriminates 21 aromatic acids in aqueous solution (see Han, J.; Wang, B.; Bender, M.; Seehafer, K.; Bunz, U. H. F. Water-Soluble Poly(p-aryleneethynylene)s: A Sensor Array Discriminates Aromatic Carboxylic Acids. ACS Appl. Mater. Interfaces 2016, 8, 20415-20421. The structures of the tested aromatic acids are similar to that of the NSAIDs. Therefore, the optimal array for the aromatic acids known from the Han et al 2016 paper was selected as a starting point for discrimination of the NSAIDs.

Two types of elements work typically well within a sensor, particularly for sensors comprised of the complexes shown in Han, J.; Bender, M.; Seehafer, K.; Bunz, U. H. Identification of White Wines by using Two Oppositely Charged Poly(p-phenyleneethynylene)s Individually and in Complex. Angew. Chem. Int. Ed. 2016, 55, 7689-7692, an, J. S.; Bender, M.; Hahn, S.; Seehafer, K.; Bunz, U. H. F., Polyelectrolyte Complexes Formed from Conjugated Polymers: Array-Based Sensing of Organic Acids. Chem. Eur. 1 2016, 22, 3230-3233 and Han, J. S.; H, W. B.; Bender, M.; Seehafer, K.; Bunz, U. H. F. Water-Soluble Poly(p-aryleneethynylene)s: A Sensor Array Discriminates Aromatic Carboxylic Acids. ACS Appl. Mater. Interfaces 2016, 8, 20415-20421 and for PAE/Protein conjugates as reported previously in Rana, S.; Elci, S. G.; Mout, R.; Singla, A. K.; Yazdani, M.; Bender, M.; Bajaj, A.; Saha, K.; Bunz, U. H. F.; Jirik, F. R.; Rotello, V. M. Ratiometric Array of Conjugated Polymers-Fluorescent Protein Provides a Robust Mammalian Cell Sensor. J. Am. Chem. Soc. 2016, 138, 4522-4529: (1) individual highly fluorescent PAEs and (2) complexes composed of a fluorophore and a quencher-PAE. A number of PAEs were synthesized. The synthesis of P1, P6, P10, P12 and P13 have been reported in Han, J. S.; Bender, M.; Hahn, S.; Seehafer, K.; Bunz, U. H. F., Polyelectrolyte Complexes Formed from Conjugated Polymers: Array-Based Sensing of Organic Acids. Chem. Eur. 1 2016, 22, 3230-3233. The synthesis of P3 and P7 have been reported in Rana, et al. above. The synthesis of P5 was reported in Kim, I.-B.; Phillips, R.; Bunz, U. H. F. Carboxylate Group Side-chain Density Modulates the pH-dependent Optical Properties of PPEs. Macromolecules 2007, 40, 5290-5293. The synthesis of P8 was reported in Bender, M.; Seehafer, K.; Findt, M.; Bunz, U. H. F. Pyridine-based Poly(aryleneethynylene)s: a Study on Anionic Side Chain Density and Their Influence on Optical Properties and Metallochromicity. RSC Adv. 2015, 5, 96189-96193. The synthesis of P11 was reported in Kim, I.-B.; Dunkhorst, A.; Gilbert, J.; Bunz, U. H. F. Sensing of Lead Ions by a Carboxylate-substituted PPE: Multivalency Effects. Macromolecules 2005, 38, 4560-4562.

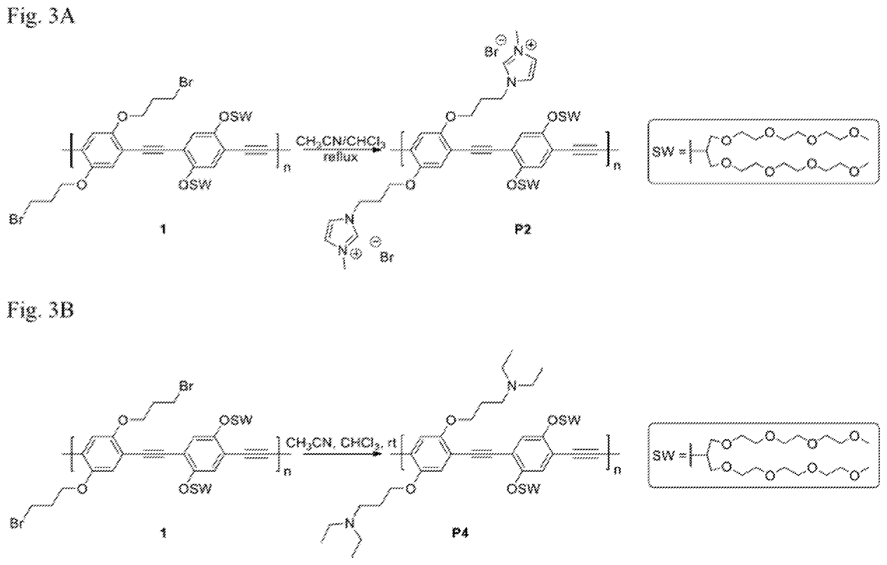

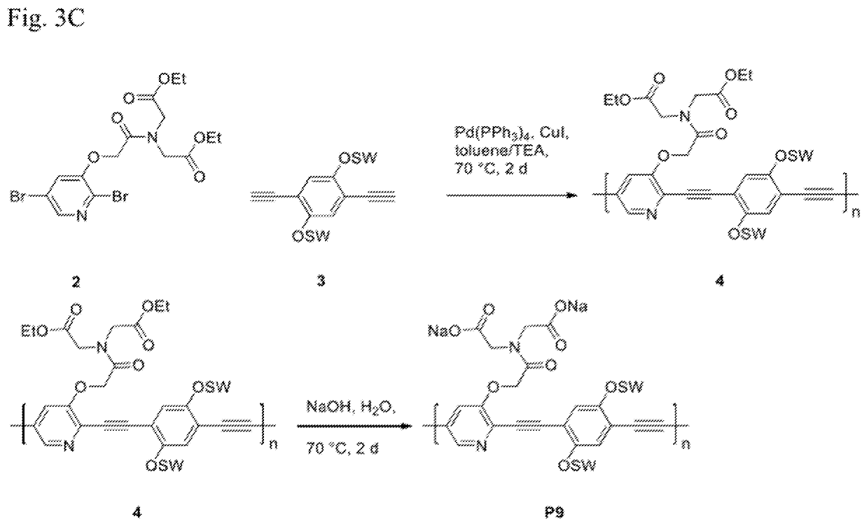

The synthesis of P2 is shown in FIG. 3A and was carried out as follows. Compound 1 (100 mg, 0.083 mmol) was dissolved in degassed CH₃CN/CHCl₃ (5 mL/2 mL). 1-Methyl-imidazole (1 mL) was added slowly and refluxed for 8 days under N₂ atmosphere. After evaporation of the solvents, the mixture was re-dissolved in distilled water and then dialyzed against DI water for 7days. Freeze-drying gave P2 as yellow solid (99 mg, 86%). The Mₙ and PDI was determined on the precursor 1 ¹H NMR (300 MHz, MeOD) δ=8.32-8.93 (d, 2 H), 7.41-7.60 (m, 4 H), 7.31-7.10 (m, 4 H), 4.58-4.34 (m, 6H), 4.01-4.28 (m, 4 H), 3.76-3.84 (m, 6 H), 3.32-3.75 (m, 56 H), 3.11-3.25 (m, 12 H), 2.31-2.46 (m, 4 H) ppm. Due to low solubility, ¹³C NMR spectrum could not be obtained. IR (cm⁻¹): v 3410, 2871, 2359, 1647, 1575, 1508, 1490, 1470, 1420, 1350, 1272, 1200, 1088, 1042, 949, 849, 623. Quantum yields (Φ=0.29).

FIG. 3B shows the synthesis of P4, which was carried out as follows. Compound 1 (275 mg, 0.228 mmol) was dissolved in degassed CH₃CN/CHCl₃ (8 mL/8 mL). Diethylamine (8 mL) was added slowly and reacted for 7 days under N₂ atmosphere at room temperature. After evaporation of the solvents, the mixture was re-dissolved in distilled water and then dialyzed against DI water for 7 days. Freeze-drying gave P4 as yellow solid (220 mg, 82%). The Mₙ and PDI was determined on the precursor 1. ¹H NMR (300 MHz, CDCl₃) δ=7.17-7.08 (m, 2 H), 7.03-6.88 (m, 2 H), 4.56-4.32 (m, 2H), 4.18-3.92 (m, 4 H), 3.87-3.38 (m, 56 H), 3.36-3.17 (m, 12 H), 2.91-2.32 (m, 12 H), 2.12-1.74 (m, 4 H), 1.17-0.86 (m, 4 H) ppm. Due to low solubility, ¹³C NMR spectrum could not be obtained. IR (cm⁻¹): v 2870, 2817, 2361, 1508, 1489, 1469, 1420, 1380, 1350, 1272, 1200, 1101, 1041, 953, 850, 718. Quantum yield (Φ=0.21).

FIG. 3C shows the synthesis of compound 4 and P9. Compounds 2 and 3 were synthesized according to the literature: Kim, I.-B.; Phillips, R.; Bunz, U. H. F. Carboxylate Group Side-chain Density Modulates the pH-dependent Optical Properties of PPEs. Macromolecules 2007, 40, 5290-5293 and Bender, M.; Seehafer, K.; Findt, M.; Bunz, U. H. F. Pyridine-based Poly(aryleneethynylene)s: a Study on Anionic Side Chain Density and Their Influence on Optical Properties and Metallochromicity. RSC Adv. 2015, 5, 96189-96193.

Under a nitrogen atmosphere, compound 2 (193 mg, 400 μmol, 1.0 eq) and compound 3 (356 mg, 400 μmol, 1.0 eq) were solved in degassed toluene (3.9 mL) and TEA (2.6 mL). Then CuI (4 mg, 20 μmol, 0.05 eq) and Pd(PPh₃)₂Cl₂ (23 mg, 20 μmol, 0.05 eq) were added, before the reaction was heated to 60° C. in a closed flask. After stirring for 24 h, the solution was allowed to reach ambient temperature. The gelatinous solution was solved in chloroform and THF (1:1, 50 mL), before it was washed with NH₄Cl_{aq} (50 mL). The two layers were separated, the aqueous layer was extracted with DCM (3×50 mL) and the combined organic layers were dried over MgSO₄ and filtered before the solvent was removed under reduced pressure. The resulting residue was dissolved in chloroform (5 mL) and precipitated in pentane (400 mL) and stirred for one hour. The suspension was filtered and the precipitate was dried in vacuum to give compound 4 as a brown solid (348 mg, 72%). The Mₙ was estimated to be 2.4×10³ with a PDI of 14. ¹H NMR (600 MHz, CDCl₃): δ=7.12-7.62 (m, 3 H), 4.97 (br. s, 2 H), 4.50-4.54 (m, 2 H), 4.06-4.30 (m, 8 H), 3.46-3.75 (m, 56 H), 3.29 (br. s, 12 H), 1.18 (br. s, 6 H) ppm. Due to low solubility, ¹³C NMR spectrum could not be obtained. IR (cm⁻¹): v 2871, 1743, 1684, 1498, 1455, 1398, 1350, 1259, 1193, 1024, 850, 804, 697, 611, 541, 500, 418 cm⁻¹. Compound 4 (148 mg, 122 μmol, 1.0 eq) was suspended in 2.5 N NaOH (1.5 mL, 50 eq) and refluxed at 50° C. for 24 h. After cooling down to room temperature, the pH-value was adjusted to 7.0 (HCl). The solution was filled into a membrane and was dialyzed for three days, before the water was removed by freeze-drying to give P9 as a rubber-like yellow solid (131 mg, 89%). ¹H NMR (600 MHz, D₂O): δ=8.28-8.37 (m, 1 H), 7.74-7.79 (m, 1 H), 5.04-5.06 (m, 2 H), 3.93-3.96 (m, 4 H), 3.46-3.84 (m, 60 H), 3.25 (br. s, 12 H) ppm. Due to low solubility, ¹³C NMR spectrum could not be obtained. IR (cm⁻¹): v 3382, 2872, 2362, 1597, 1499, 1453, 1397, 1198, 1094, 1031, 934, 845, 718, 539, 427, 416 cm⁻¹. Quantum yield (Φ=0.16).

The positively charged P1 and P3 (not shown), neutral P4 (not shown) and negatively charged P5 (not shown) and four fluorophore-quencher type complexes (C1-2, C1-7 (not shown), C1-8 (not shown) and C1-9(not shown)) were screened at different pH values. It was found that a sensor array comprising a cationic poly(para-phenyleneethynylene) (PPE) P1 and its electrostatic complex C (C1-2) with the weakly fluorescent high-density charged P2 at pH 10 and pH 13 works well to discriminate between the different ones of the NSAIDs (FIG. 2B).

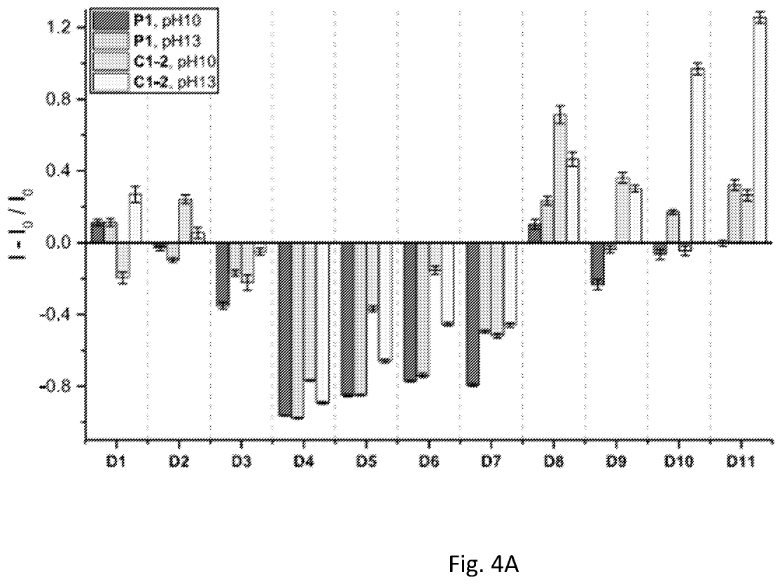

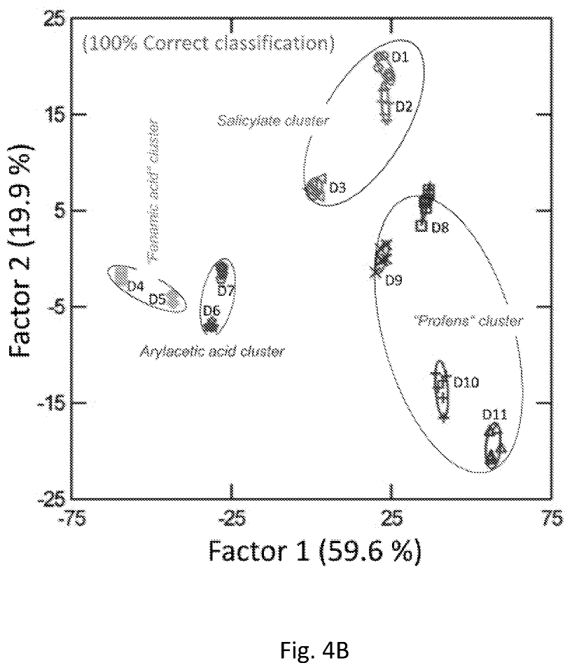

The eleven NSAIDs of FIG. 1 show varied responses towards this sensor array, as can be seen in FIG. 4A. Processing these data by linear discriminant analysis (LDA, sextuplet data sets), one discriminates all of the NSAIDs according to their Mahalanobis distances, employing two dimensionless factors. The LDA converts the training matrix (4 factors×11 NSAIDs×6 replicates) into canonical scores. The first two canonical factors shown in FIG. 4B represent 80% of the total variation. The canonical scores are clustered into eleven different groups. The jack-knifed classification matrix with cross-validation reveals 100% accuracy and the sensor system successfully discriminates the different NSAIDs.

FIG. 4A shows a fluorescence response pattern (I-I₀/I₀) obtained by P1 (500 nM, at pH 10 and 13, buffered) and its complex C (P1-P2 at 500 nM-250 nM, at pH 10 and 13, buffered) treated with NSAIDs D1-D11 (6 mM). Each value is the average of six independent measurements; each error bar shows the standard deviation of these measurements. FIG. 4B shows a 2D canonical score plot for the first two factors of simplified fluorescence response patterns obtained with the sensor array comprising P1, C (each at pH 10 and 13, buffered) with 95% confidence ellipses. Each point represents the response pattern for a single analgesic to the array. The canonical scores are clustered into eleven different groups. The jack-knifed classification matrix with cross-validation reveals 100% accuracy.

To validate its efficiency, tests were performed with randomly chosen ones of the NSAID samples of the training set. The new cases are classified into groups, generated through the training set, based on their shortest Mahalanobis distance to the respective group. All of the 44 tested unknown NSAID samples were correctly identified using the sensor array and the training set. In the 2D LDA plot (FIG. 4B), results from eleven NSAIDs clustered independently in accordance to their structural similarity. Super groups form, i.e. all salicylates cluster differently than the profens, the fenamic acids and the arylacetic acids.

A Concentration Dependent Discrimination of ‘Fenamic Acid’—NSAID D4 was now investigated.

The fluorescence modulation data for the NSAID D4 was recorded at concentrations from 0 to 1.8 mM. The LDA converts the training matrix (4 factors×D4, nine concentrations×6 replicates) into nine canonical scores. The first two canonical factors represent 94% of the total variation. The jack-knifed classification matrix with cross-validation reveals 100% accuracy. Eight different concentrations (without control, 0 mM) of the NSAID D4 from the training set were randomly chosen for blind testing. The new cases are classified into groups, generated through the training matrix, based on their shortest Mahalanobis distance to the respective group. Among 32 unknown concentration samples, all were classified correctly.

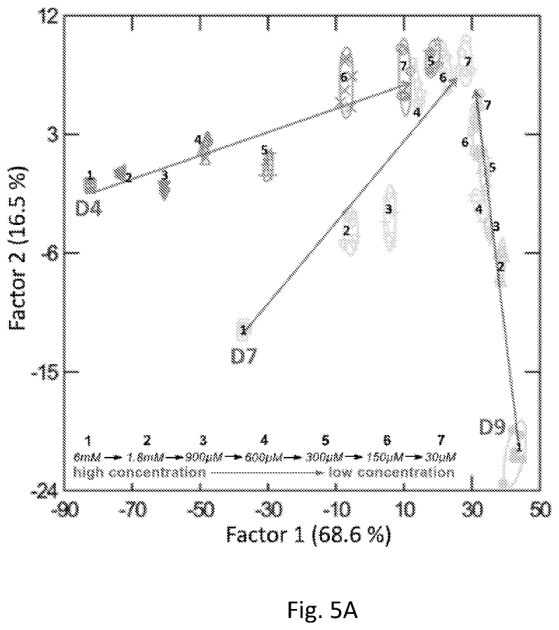

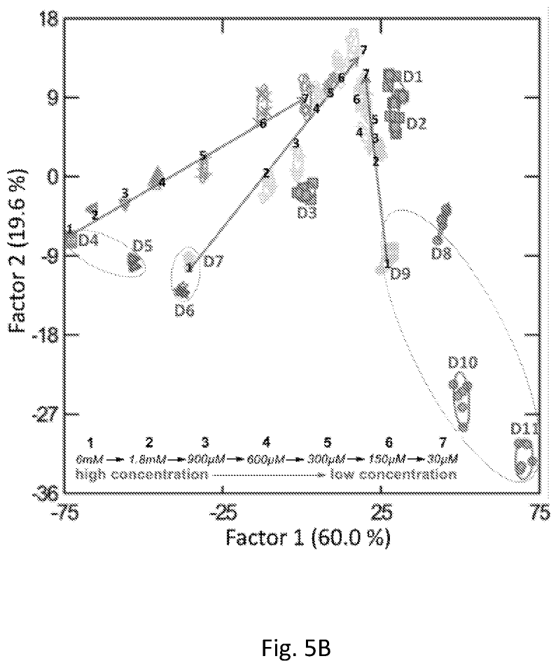

The concentration is linearly mapped in the LDA plot, with the zero-point in the upper right-hand corner (FIG. 5A). The same experiment was performed with the NSAIDs D7 and D9, and here also the concentration is linearly correlated with the response. This suggests that for every NSAID we have a slice of exclusion where one can identify NSAIDs at unknown concentrations without interference from other NSAIDs. There is a corollary to this: if two or more NSAIDs are on the same vector connecting to the origin, then their concentration dependent profiles cannot be discerned. However, in the other cases one should be able to obtain both structure and concentration from an unknown sample, even though at low concentrations this would become increasingly difficult. FIG. 5B depicts the concentration dependent data in the context of all of the other NSAIDs. The cases that cannot be discerned when different concentrations are allowed are the NSAIDs D6, D7 or D1, D2, D8, D10, D11. In an ideal case, the concentration dependent slope would be significantly different for each and any NSAID.

TABLE 2
Detailed Information of the ten Over-the-Counter (OTC)
NSAIDs used in this study

| | Brand name | Main/total | |
|---|---|---|---|
| Abbr. | (Company) | (mg) ^{a} | Side ingredients |
| ASS1 | ASS- | 500/620 | corn starch, cellulose powder |
| | Ratiopharm ® | | |
| | (Ratiopharm) | | |
| ASS2 | Aspirin ® | 500/670 | Na₂CO₃, highly dispersed SiO₂, |
| | (Bayer) | | carnauba wax, hydroxypropyl- |
| | | | methylcellulose (HPMC), Zn- |
| | | | stearate |
| ASS3 | ASS 500 mg | 500/620 | micro-crystalline cellulose, corn |
| | HEXAL ® | | starch |
| | (Hexal AG) | | |
| ASS4 | ASS 500-1A | 500/620 | micro-crystalline cellulose, corn |
| | Pharma ® | | starch |
| | (1A Pharma) | | |
| ASS5 | ASS STADA ® | 500/650 | micro-crystalline cellulose, corn |
| | (STADA | | starch |
| | pharm) | | |
| IBU1 | Ibuflam ® akut | 400/590 | microcrystalline cellulose, corn |
| | (Winthrop) | | starch, lactose monohydrate, E468, |
| | | | highly dispersed SiO₂, Mg-stearate, |
| | | | polyvinylalcohol, Macrogel 3350, |
| | | | talcum powder |
| IBU2 | IbuHEXAL ® | 400/480 | microcrystalline cellulose, E468, |
| | akut (Hexal | | HPMC, Macrogel 400, Mg-stearate, |
| | AG) | | highly dispersed SiO₂, talcum |
| | | | powder, TiO₂ |
| IBU3 | Ibu 400 akut-1A | 400/480 | microcrystalline cellulose, E468, |
| | Pharma ® | | HPMC, Macrogel 400, Mg-stearate, |
| | (1A Pharma) | | highly dispersed SiO₂, talcum |
| | | | powder, TiO₂ |
| IBU4 | Ibuprofen AL | 400/680 | Mg-stearate, corn starch, Macrogel |
| | 400 (ALIUD | | 400, 6000, carboxymethyl starch |
| | PHARMA) | | sodium, HPMC |
| IBU5 | Dolormin ® | 400/820 | Microcrystalline celluloses, povidon, |
| | (McNeil) | | Mg-stearatete, TiO₂, hydroxypropyl |
| | | | cellulose, HPMC |

^{a} The weight of the main ingredient and the total weight of each tablet.

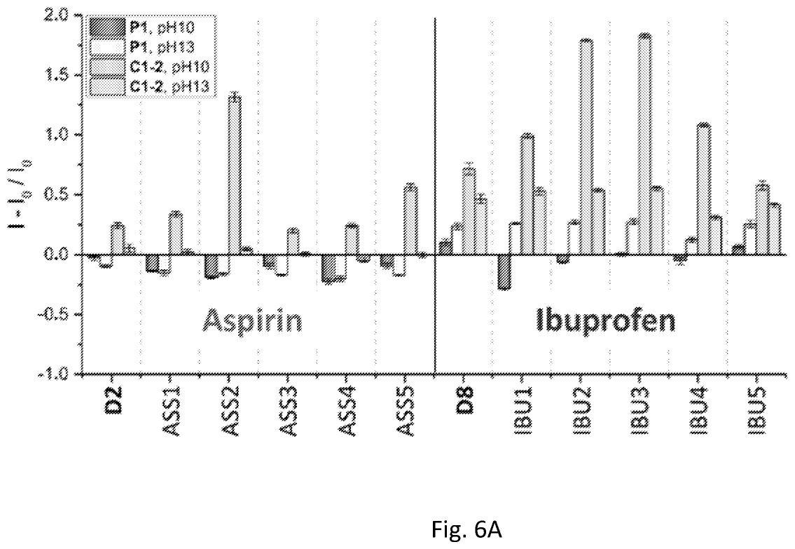

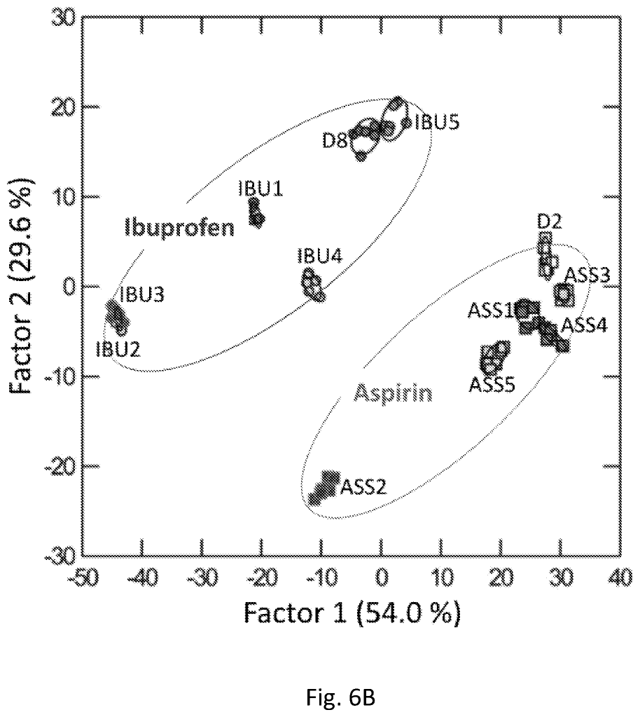

Sensing of OTC Samples (Aspirin and Ibuprofen) was now carried out. The test was the identification and discrimination between different, commercially available NSAIDs. Different fillers, super-disintegrants etc. are present in varying concentrations. Five commercially available samples of aspirin and five samples of ibuprofen were selected. Table 2 shows the composition and the weight of all of the ingredients according to the package insert. FIGS. 6A and 6B show the fluorescence responses of the different ibuprofen and aspirin samples. For aspirin, the sample ASS2 is the least fitting in this series, probably due to the presence of colored carnauba wax, (yellow/brown) in the sample. The other ASS-samples cluster closely. In the case of the ibuprofens, the two samples IBU2, 3 cluster and are away from the data point for the NSAID D8. IBU2, 3 contain titanium dioxide, another ingredient that will interfere with the fluorescence modulation of the chemical tongue by ibuprofen. The other IBU samples cluster more closely. The super cluster of the IBUs does not overlap with the super cluster of the ASS-species.

FIG. 6A shows the fluorescence response pattern (I-I₀/I₀) obtained by P1 (500 nM, at pH 10 and 13, buffered) and complex C1-2 (P1-P2 at 500 nM-250 nM, at pH 10 and 13, buffered) treated with NSAIDs D2 (aspirin, 6 mM, control) and D8 (ibuprofen, 6 mM, control) and commercial available OTC tablet aspirin (ASS1-ASS5, 6 mM), ibuprofen (IBU1-IBU5, 6 mM). FIG. 6B shows a 2D canonical score plot for the first two factors of simplified fluorescence response patterns obtained with an array of P1, C1-2 (each at pH 10 and 13, buffered) with 95% confidence ellipses. Each point represents the response pattern for a single analgesic to the sensor array.

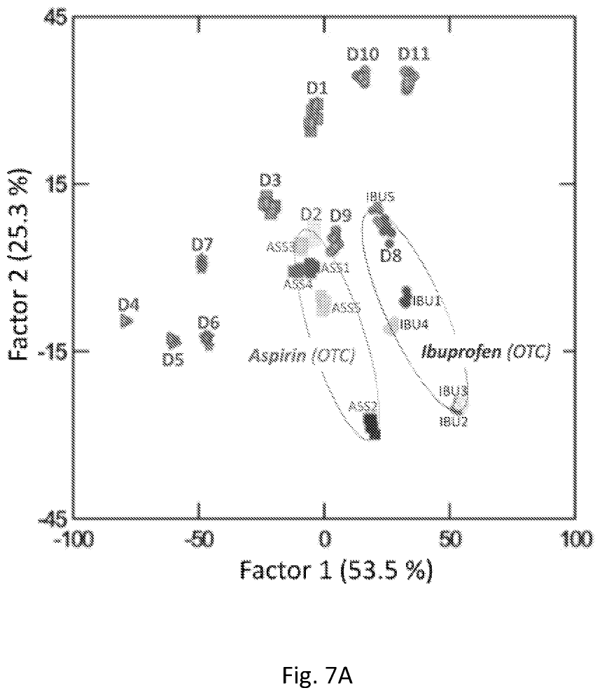

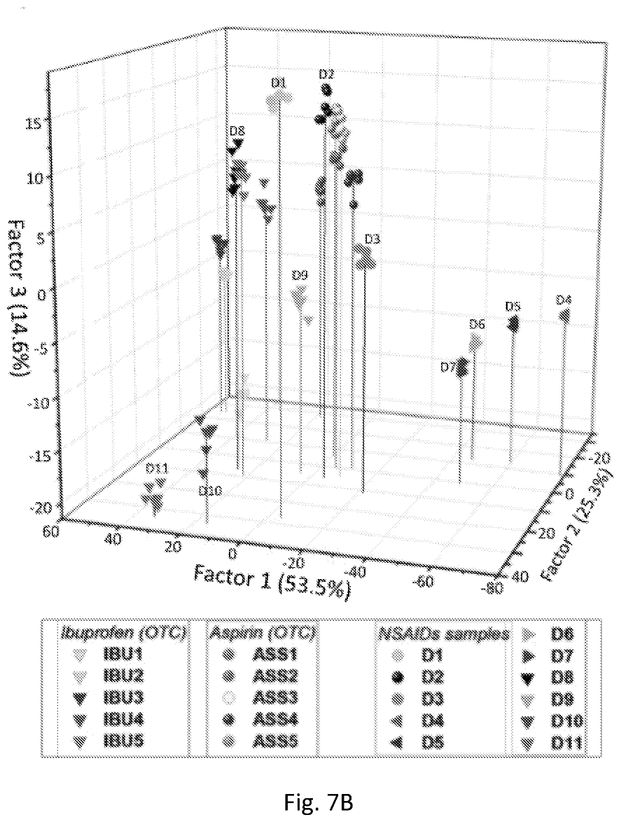

Once we co-process the data employed for FIG. 6B with all of the data obtained for the other NSAIDs, we find that the IBU and the ASS samples form super clusters that do not overlap with any of the other NSAIDs (here shown in grey, FIGS. 7A-7B). The response to the sensor field in the sensor array, while modulated by the additives and formulations, is fundamentally determined by the active drug component. The selected sensor field—in combination with LDA—easily handles these discriminative tasks.

FIG. 7A shows a 2D canonical score plot and FIG. 7B shows a 3D canonical score plot obtained with an array of P1, C1-2 (each at pH 10 and 13, buffered) treated with NSAIDs D1-D11 and commercial available OTC tablet aspirin (ASS1-ASS5), ibuprofen (IBU1-IBU5). Each point represents the response pattern for a single analgesic to the array. The grey/black colours represent pure analgesics, the colorful shape represent the OTC aspirin and ibuprofen.

The four-element sensor array comprising a highly fluorescent cationic PPE and its complex with a weakly fluorescent anionic PAE is merely exemplary. In this example, both highly fluorescent cationic PPE and its complex with a weakly fluorescent anionic PAE (at pH 10 and pH13) discern eleven different NSAIDs, even at different concentrations. The sensor array is able to identify and discriminate commercial NSAIDs (over-the-counter ibuprofen and aspirin). The different ibuprofens and aspirins cluster together. It is still possible to identify a tablet from a specific drug maker. This successful discrimination demonstrates the power of these sensor arrays composed of weakly selective elements.

The sensor arrays work by a combination of hydrophobic and electrostatic interaction of the analytes with the conjugated polymer(s) or with their formed complex(es). These hydrophobic and electrostatic interactions are magnified due to fluorescence based detection. The excited state of the fluorophores is far more responsive towards external stimuli than the ground state.

The array sensor described in this document works well and surpasses in its flexibility and discriminatory power prior art specific sensors. Such specific sensors often do not exist (at any rate) for discrimination of even fairly simple or complex analytes we are interested in. McQuade, D. T.; Pullen, A. E.; Swager, T. M. Conjugated Polymer-based Chemical Sensors. Chem. Rev. 2000, 100, 2537-2574 and Thomas III, S. W.; Joly, G. D.; Swager, T. M. Chemical Sensors Based on Amplifying Fluorescent Conjugated Polymers. Chem. Rev. 2007, 107, 1339-1386. This suggests that the sensor array described in this document has an enormous potential fundamentally but also for application, particularly if transparent and easily applicable rules are developed that connect analyte class to an appropriate fluorophore and quencher type.

It is also suggested that the sensor array of this document enables discrimination of fake and/or adulterated drug formulations.

In a second aspect of the concept, a sensor array for the detection of fruit juices was investigated.

Sample Preparation. 14 apple juices (AJ1-AJ14), 5 black currant juices (BJ1-BJ5) and 6 red grape juices (GJ1-GJ6 (detailed information see Table 2) were purchased from local supermarkets and used directly in our discrimination experiments with P1 and P2. The pH values were measured immediately after opening with a pH-meter. Chemicals, solvents and buffers (pH 3, citric acid/NaOH/NaCl; pH 7, KH₂PO₄/Na₂HPO₄; pH 13, glycine/NaOH/NaCl) were purchased from commercial laboratory suppliers. Reagents were used without further purification unless otherwise noted.

TABLE 2
Detailed Information of the Investigated Juices (14 Apple Juices AJ1-AJ14, 5
Black Currant Juices BJ1-BJ5 and 6 Red Grape Juices GJ1-GJ6)

| | | | | | Crbohydrates/ | | |
|---|---|---|---|---|---|---|---|
| Abbr. | Commercial Juice Name | pH^{a} | Conc. | Fat/Fatty acids^{b} | Sugar^{b} | Proteins^{b} | Salts^{b} |
| AJ1 | ^{Bio}Apple Juice | 3.47 | 100% | <0.5 g/0.5 g | 11.0 g/10.0 g | <0.5 g | <0.01 g |
| AJ2 | Apple Juice | 3.40 | 100% | 0.1 g/0.02 g | 11.0 g/10.5 g | 0.1 g | 0.005 g |
| AJ3 | Riod'oro Apple Juice | 3.49 | 100% | <0.1 g/0.1 g | 10.3 g/9.9 g | 0.1 g | <0.01 g |
| AJ4 | Riod'oro Premium Apple | 3.41 | 100% | 0 g/0 g | 11.0 g/11.0 g | 0 g | 0 g |
| | Juice | | | | | | |
| AJ5 | REWE Apple Juice | 3.50 | 100% | 0 g/0 g | 11.2 g/10.7 g | 0 g | 0 g |
| AJ6 | Albi Apple Juice | 3.60 | 100% | <0.5 g/<0.1 g | 11.0 g/10.0 g | <0.5 g | <0.01 g |
| AJ7 | ^{Bio}Solevita Bio Apple Juice | 3.56 | 100% | 0.1 g/<0.1 g | 11.0 g/10.5 g | 0.1 g | <0.01 g |
| AJ8 | VITAFIT Apple Juice | 3.60 | 100% | 0.1 g/0.02 g | 10.5 g/10.0 g | 0.1 g | <0.01 g |
| AJ9 | VITAFIT Premium Apple | 3.63 | 100% | 0.1 g/0.02 g | 11.0 g/10.5 g | 0.1 g | <0.01 g |
| | Juice | | | | | | |
| AJ10 | Amecke Apple Juice | 3.65 | 100% | 0.1 g/<0.1 g | 11.1 g/10.6 g | 0.5 g | 0.01 g |
| AJ11 | Ja Apple Juice | 3.56 | 100% | 0 g/0 g | 10.2 g/9.8 g | 0 g | 0.01 g |
| AJ12 | EDEKA Apple Juice | 3.73 | 100% | 0.1 g/0.02 g | 10.5 g/10.0 g | 0.1 g | 0.008 g |
| AJ13 | Lift Apple spritzer | 3.53 | 55% | 0 g/0 g | 6.0 g/5.8 g | 0 g | 0 g |
| AJ14 | ^{c}Hessischer Apple Wine | 3.76 | 5.5% | — | — | — | — |
| | | | Alcohol | | | | |
| BJ1 | ^{Bio}Cassis Black Currant | 3.10 | 30% | 0 g/0 g | 82 g/82 g | 0 g | 0 g |
| | juice | | | | | | |
| BJ2 | ^{Bio}Nektar Black Currant | 3.60 | 25% | 0.1 g/0.02 g | 13 g/13 g | 0.1 g | 0.001 g |
| | juice | | | | | | |
| BJ3 | Heimishe Black Currant | 3.60 | 25% | <0.5 g/<0.1 g | 12 g/12 g | 0.1 g | <0.01 g |
| | juice | | | | | | |
| BJ4 | REWE Black Currant juice | 3.54 | 25% | 0 g/0 g | 12.9 g/12.9 g | 0.3 g | 0.01 g |
| BJ5 | Jacoby Black Currant juice | 3.57 | 25% | <0.5 g/<0.1 g | 8.4 g/8.4 g | <0.5 g | <0.01 g |
| GJ1 | ^{Bio}Grape juice | 4.06 | 100% | 0.01 g/0.002 g | 17 g/17 g | 0.2 g | 0.003 g |
| GJ2 | ^{Bio}REWE Red Grape juice | 4.07 | 100% | 0 g/0 g | 16.6 g/16.6 g | 0 g | 0 g |
| GJ3 | REWE Grape juice | 3.92 | 100% | 0 g/0 g | 16.9 g/16.9 g | 0 g | 0 g |
| GJ4 | Riod'oro Premium Grape | 3.68 | 100% | 0 g/0 g | 16.6 g/16.6 g | 0 g | 0 g |
| | juice | | | | | | |
| GJ5 | Jacoby Grape juice | 3.77 | 100% | <0.5 g/<0.1 g | 16 g/16 g | <0.5 g | <0.01 g |
| GJ6 | REWE Merlot Grape juice | 3.63 | 100% | 0 g/0 g | 17 g/17 g | 0.3 g | 0.01 g |

^{a}Measured immediately after opening.
^{b}Contents per 100 ml, information obtained from the label.
^{c}Apple Wine.
^{Bio}with BIO label of the Europe union.

Preparation of red and green grape juice: Seedless green grapes, Sugraone, Spain, 500 g, and red grapes Summer Royal, Italy, 500 g, were purchased from local supermarkets. Grapes were removed from their stems and washed with cold water, drained off and mashed with a potato masher. The resulting grape sludge was centrifuged with an ultracentrifuge Beckman L7-55, 20000 rpm, 0.5 h, 20° C. to isolate clear grape juice as supernatant.

Black currant juice: black currants, Germany, 500 g, were purchased from local supermarkets. The black currants were washed and de-stemmed. 250 mL of water were added, the mixture was mashed with a potato masher and heated for 10 min to gentle boil to furnish 550 mL of a thick solution. Ultracentrifugation (20000 rpm, 0.5 h, 20° C.) furnished a clear dark black currant juice, which was diluted to 40% of its original concentration by distilled water.

Fluorescence response patterns. Emission spectra were recorded and analyzed on a CLARIOstar (firmware version 1.13) Platereader (BMG Labtech, built in software, version 5.20 R5). Data were analyzed by CLARIOstar MARS Data Analysis Software (version 3.10 R5) from BMG Labtech. The specific response for each analyte was measured six times, the peak values acquired. These were used as the observables for the subsequent linear discriminant analysis (LDA).

LDA. The acquired data were evaluated by LDA in SYSTAT (version 13.0). In LDA, all variables were used in the model (complete mode). The tolerance was set as 0.001. The fluorescence response patterns were transformed to canonical patterns. The Mahalanobis distances of each individual pattern to the centroid of each group in a multidimensional space were calculated and the assignment of the case was based on the shortest Mahalanobis distance.

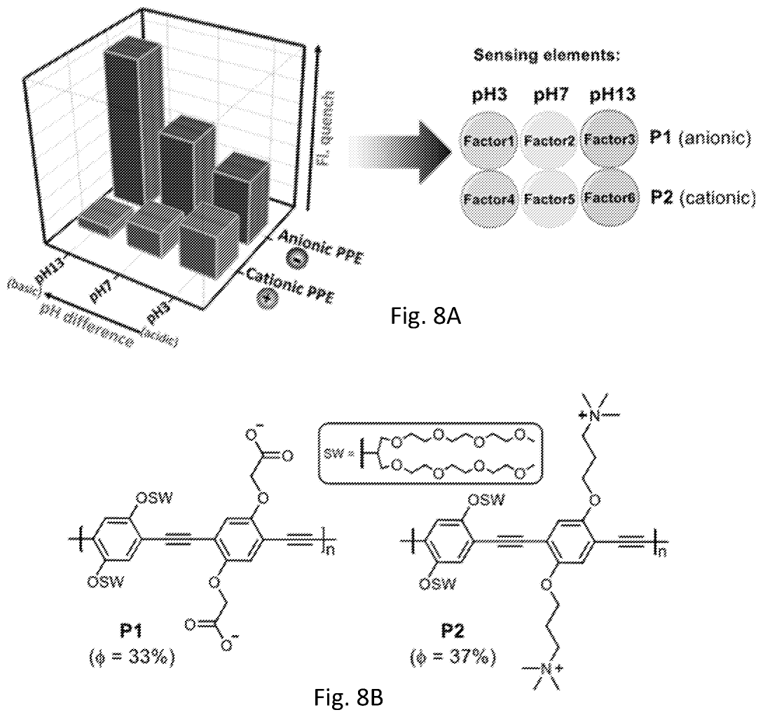

The structure of P1 and P2 is shown in FIG. 8B and their preparation described in Han, J.; Bender, M.; Seehafer, K.; Bunz, U. H. Identification of White Wines by using Two Oppositely Charged Poly(p-phenyleneethynylene)s Individually and in Complex. Angew. Chem. Int. Ed. 2016, 55, 7689-7692. Fluorescence response pattern and linear discriminant analysis was carried out on the two polymers P1 and P2 to identify their suitability for use in the sensor array. Preliminary screening was done recording fluorescence patterns with different PAEs in presence of the analyte. Using the response patterns with the highest distinction yielded a workable tongue showing six elements, consisting of P1 and P2 at different pH values (pH 3, pH 7 and pH 13). P1 is anionic (FIG. 8B) while P2 is positively charged; both are highly fluorescent in water (FIG. 8A). FIG. 8A shows the results of a systematic evaluation and selection of the successful tongue elements of the sensor array for the juice sensing and FIG. 8B shows the chemical structures and quantum yields (ϕ) of P1 and P2.

Table 2 shows the different apple, grape and black currant juices in this study. Juices, complex mixtures of different compounds, the number of which probably ranges in the hundreds, are 8-17% aqueous solutions of sugar at a pH between pH 3.1-4.1. Their low pH prevents fast microbial spoiling. As a first juice experiment, all of the juices were exposed towards PPE P1 and P2.

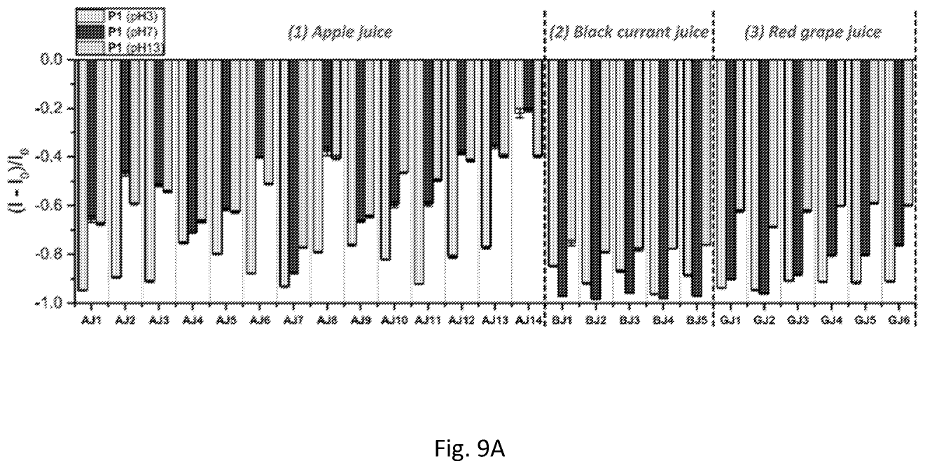

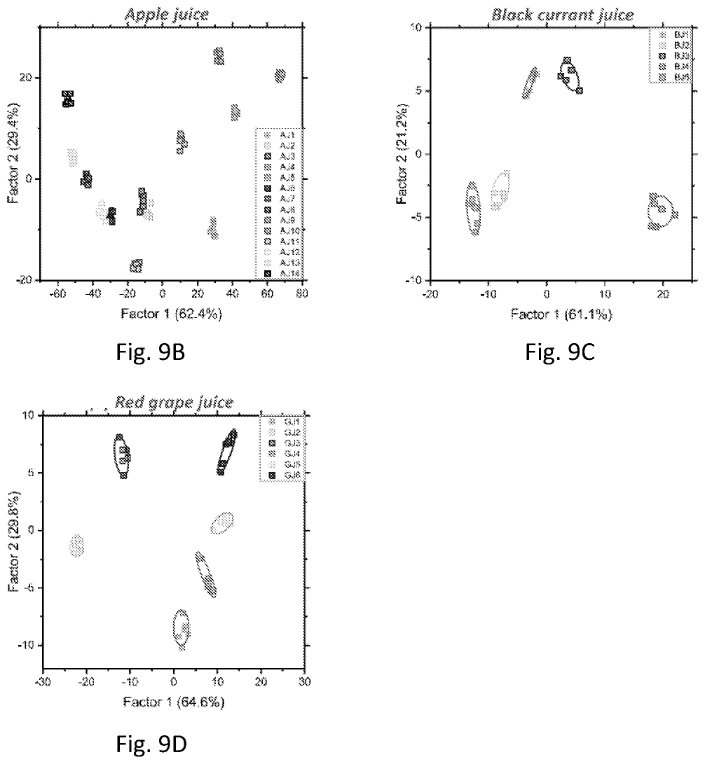

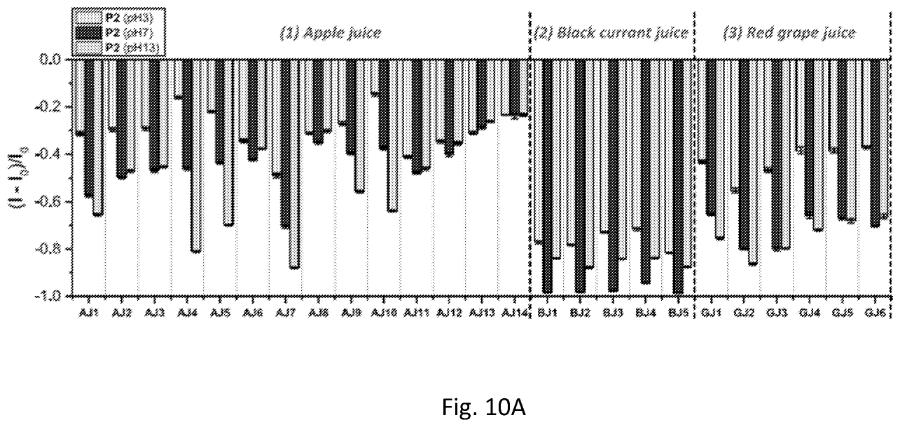

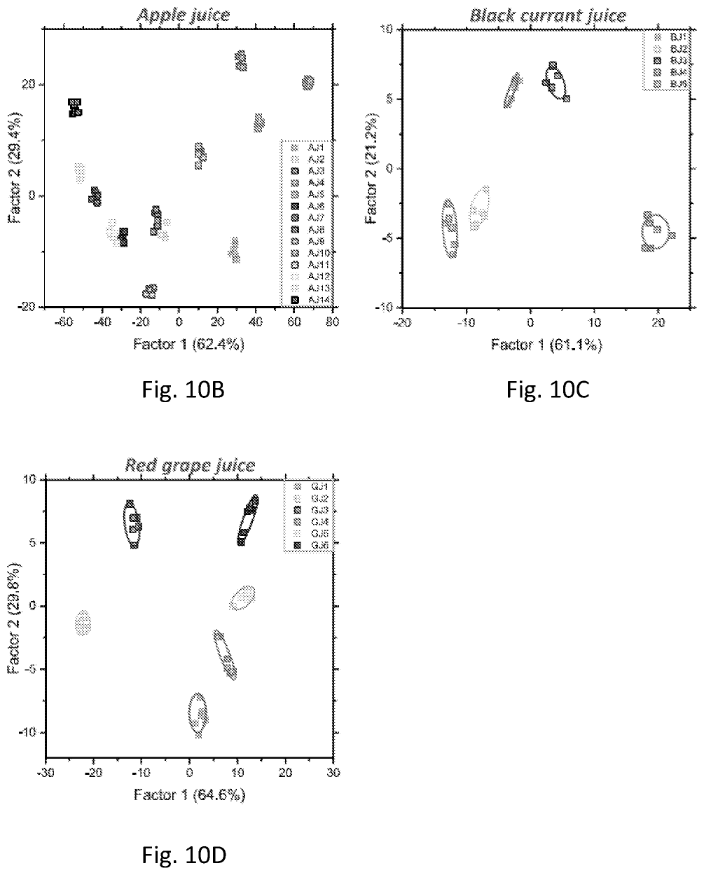

FIGS. 9A-9D and 10A-10D show the quenching results of the PPEs when the juices are added at different pH values. FIGS. 9A-9D and 1-A-10D show fluorescence response patterns (I-I₀/I₀) obtained by P1 (2 μM, at pH 3, pH 7 and 13, buffered) and by P2 (2 μM, at pH 3, pH 7 and pH 13, buffered) treated with commercial apple juice (1), black currant juice (2) and red grape juice (3) samples (50 μL per 300 μL for P1 and 1 μL per 300 μL for P2). Each value is the average of six independent measurements; each error bar shows the standard deviation of these measurements. FIGS. 9A-9D and 10A-10D show the canonical score plots for the first two factors of simplified fluorescence response patterns obtained with an array of P1 and P2 with 95% confidence ellipses. Each point represents the response pattern for a single juice sample to the array.

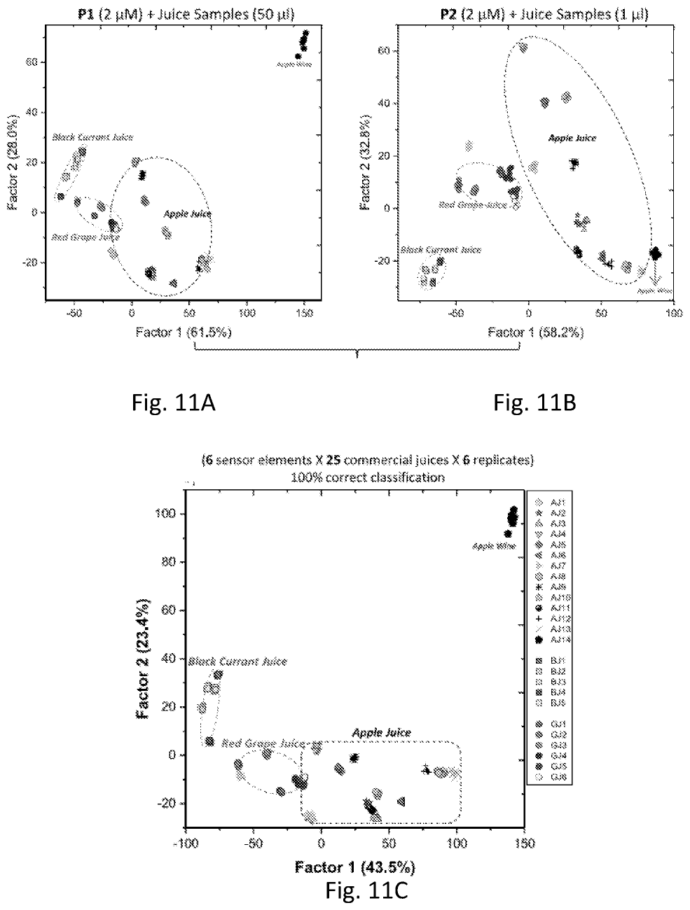

FIG. 11A shows a combined 2D canonical score plot obtained with an array of P1 (2 μM, at pH 3, 7, 13, buffered) treated with apple, black currant and red grape juices (50 μL). FIG. 11B shows a combined 2D canonical score plot obtained with an array of P2 (2 μM, at pH 3, 7, 13, buffered) under the same conditions using 1 μl of juice. FIG. 11C shows a combined 2D LDA plot for the first two factors of simplified fluorescence response patterns from six sensing elements obtained from P1 (pH 3, pH 7 and pH 13) and P2 (pH 3, 7, 13, buffered) using the same selection of 25 juices.

The fluorescence quenching of the cationic polymer P2 is much more effectively quenched (1 μL analyte vs. 50 μL analyte per 300 μL buffer/PPE solution) than that of the anionic P2. This behavior suggests that electrostatic effects play a role in the discrimination of the fruit juices. The major fluorescence quenching “interactome” of the fruit juices with the PPEs is negatively charged, allowing a strong interaction with the positively charged PPE P2. All of the fruit juices are discriminated either by P1 or by P2, when working at the three different pH values used in the example. Discrimination is possible when inspecting the raw data but it is much better visualized after linear discriminant analysis (LDA) of the data. FIG. 11C combines the response results from all juices after LDA. Both P1 as well as P2 discriminate all of the fruit juices. P2 does a better job at the discrimination, as all of the red grape juice and the black currant juices are discriminated. For unknowns, P2 is not perfect for apple juice, while P1 is not optimal for grape juice. The black currant juices are discriminated by both P1 and P2. LDA of the combination of data extracted from P1 and P2 (FIG. 11C, totally six sensing elements), results in improved discrimination. The jackknifed classification matrix with cross-validation reveals a 100% accuracy, the randomly chosen 100 unknown juice samples using combined six elements were calculated with the training matrix. The accuracy increased to 100%. A more detailed fingerprint is conferred on each juice with the increase of sensing elements (Table 3).

It is seen that the sensor array is more discriminating for single juice elements, the inter group differentiation between apple juice and red grape juice is less pronounced than for P2 alone (Table 3).

TABLE 3
Jackknifed Classification Matrix Obtained From LDA P1 and P2 at Three
Different pH-Values.^{a}

| | | Sensing elements | | | | | | |
|---|---|---|---|---|---|---|---|---|
| | | P1 (pH 3, pH 7 and | | | P2 (pH 3, pH 7 and | | | |
| | | pH 13) | | | pH 13) | | | Combined |
| | | Juice types | | | | | | |
| | | AJ | BJ | GJ | AJ | BJ | GJ | All types |
| Jackknifed | Number of | 84 | 30 | 36 | 84 | 30 | 36 | 150 |
| classification | samples | | | | | | | |
| matrix | Correctly | 83 | 30 | 35 | 84 | 30 | 36 | 150 |
| | classified | | | | | | | |
| | Accuracy | 98.8 | 100 | 97.2 | 100 | 100 | 100 | 100 |
| | (%) | | | | | | | |
| Blind test | Unknown | 56 | 20 | 24 | 56 | 20 | 24 | 100 |
| | samples | | | | | | | |
| | Correctly | 56 | 20 | 22 | 54 | 20 | 24 | 100 |
| | identified | | | | | | | |
| | Accuracy | 100 | 100 | 92 | 96 | 100 | 100 | 100 |
| | (%) | | | | | | | |

An important question arises, if some of the claimed grape juices are not pure grape juices. They might be mixtures of red grape juice with blackcurrant juice. Would it be possible to distinguish such mixtures of red grape juice with blackcurrant juice? Admixing black currant juice deepens the colour of red grape juice if that is desired. To test this hypothesis, the sensor array comprising the P2 tongue at pH 3, 7 and 13 was selected under standard conditions (1 μL juice/300 μL matrix). We added black currant juice B4 or B5 to either G6 or G1. If one does this, B4 can substitute up to 50% of G6 or G1 and the mixture is still identified as red grape juice. The alternative does not work, i.e. if one adds grape juice towards black currant juice, P2 indicates leaving the area that is assigned by LDA to the black currant juice. To obtain more insight we tested fruit juices we prepared in our laboratory from commercially available green and red grapes, and black currants.

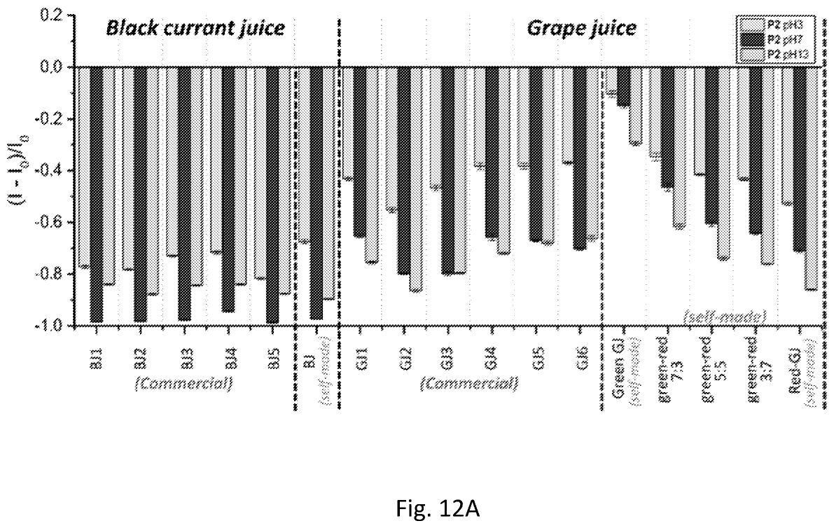

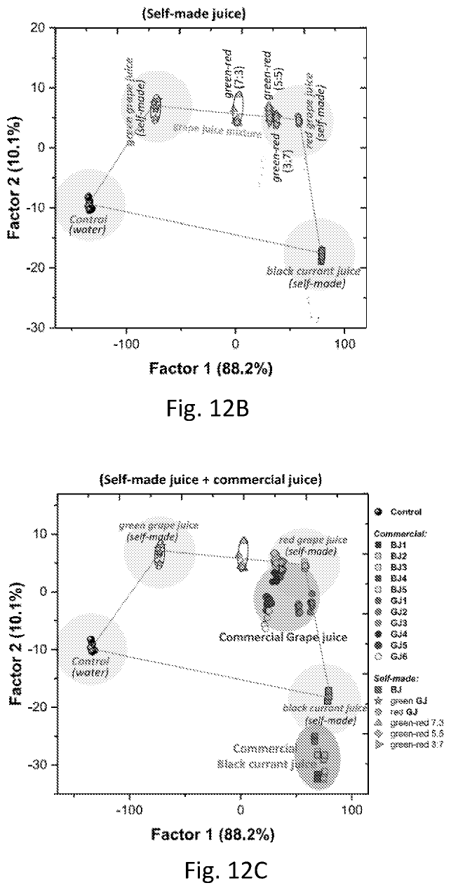

FIGS. 12A-12C show the fluorescence response of the self-made juices (blackcurrant, green grapes, red grapes) and mixtures of red and green grape juices. After LDA from the data obtained for the self-prepared juices, it is found that the admixing of the red and green grape juices is an additive process with respect to their properties expressed by LDA. The hot extracted blackcurrant juice does not group with the commercial blackcurrant juices, suggesting that commercial black currant juice is processed differently. The main discriminating factor in FIGS. 12A-12C (x-axis, Factor 1) expresses color and the quenching ability of the juices. The green grape juice, the least coloured juice is placed on the left-hand side, while blackcurrant juice samples are placed on the right hand side. The red grape juices locate in the middle. The same applies for FIGS. 11A-11C, where the response of all of the fruit juices are displayed. The x-axis approximates the color depth of the juices, just mirror-symmetrical from the ordering seen in FIGS. 12A-12C. The y-axis is currently not ascribed to a simple physicochemical property and can neither be correlated with sugar content nor with acidity. It must represent a complex property or properties; it could be a combination of fruit acids (mandelic acid, citric acid, tartaric acid etc.) and/or sugar plus other complex coloured species present in these fruit juices.

It is therefore found that a single positively charged, water soluble conjugated polymer, P2, discriminates apple juices, black currant juices and grape juices. It was established that red grape juice can be mixed with black currant juice into a zone where the LDA-processed responses of a significant number of commercially available (pure) grape juices are located. The result poses several questions. a) Some of the commercial red grape juices might contain small to moderate amounts of black currant juice or b) the variation of the response of grape juices is—due to the multiple dozens of different grape varietals—to be expected, or c) our tongue is not sufficiently developed to discriminate mixtures, or all of the above.

The minimalist nature of the sensor array is surprising, as the discriminative power of P2 is brought out by its employ at different pH-values, i.e. only change of the sensing conditions. This one polymer acts therefore as an efficient three-element-tongue, where the change of the analytes with the pH-value must significantly contribute towards the successful recognition strategy. Why are P1 and P2 successful in discriminating complex analytes such as fruit juices? P1 and P2 display a fairly rigid backbone, and—depending upon their conformation—could either be viewed as a “sticky” molecular board (phenyl rings parallel to each other) or a “sticky” molecular rod (phenyl rings twisted with respect to each other). The stickiness or non-specific affinity towards arbitrary analytes comes from hydrophobic interactions, hydrogen bonding, and electrostatic interactions. All of these interactions must be promiscuous and non-specific, as our sticky boards/rods have no inbuilt shape recognition elements and neither do they show great variations in their chemical structure, not even upon protonation. These results shed a different light on both the lock-and-key principle discussed in the introduction, but also on the professed need to employ chemically different tongue elements (Suslick) to reach recognition. Neither of these constraints are active in our boards or rods, just the presence of a molecular surface with varying “stickiness” or non-specific affinity for interactions with complex analytes.

Sticky linear molecular surfaces such as in our PPEs are powerful as they allow the sensing and the discrimination of almost all and any conceivable analytes because of the complete lack of shape requirements for either analytes or tongue elements.

If one looks into the identification of counterfeit products, drugs, or consumer goods, the absence of a clearly identifiable signal molecule means that counterfeit and adulterated products are more easily recognized as the signal generation and identification process is complex and unknown to both the counterfeiter but also the legal producer of the analyzed product, making potential protection stronger. The results show a minimalist chemical tongue made from P2 for use in the sensor array that is able to discriminate fruit juices at different pH-values without any problem.

The sensor array of the document has been further used to identify different types of teas. 8 black teas, 6 green teas and 8 oolong teas were investigated as shown in the table below.

TABLE 4
Detailed information on the investigated teas (8 black teas B1-B8,
6 green teas G1-G6 and 8 oolong teas O1-O8) used in this study.

| Name | | Fermentation | | Geographical |
|---|---|---|---|---|
| abbreviation | Category | degree | brand | origin |
| B1 ^{a} | Black tea | Fermented | Teekanne | ASSAM |
| B2 | Black tea | Fermented | Teekanne | ASSAM |
| B3 | Black tea | Fermented | Teekanne | Ostfriesen |
| B4 | Black tea | Fermented | Teekanne | Darjeeling |
| B5 | Black tea | Fermented | Meβmer | Darjeeling |
| B6 | Black tea | Fermented | Tee | Nepal |
| | | | Gschwendner | |
| B7 | Black tea | Fermented | Tee | Nordindien |
| | | | Gschwendner | |
| B8 | Black tea | Fermented | Tee | Darjeeling |
| | | | Gschwendner | |
| G1 ^{b} | Green tea | Non- | Longjing | Hangzhou Xihu |
| | | fermented | | |
| G2 ^{b} | Green tea | Non- | Longjing | Hangzhou Xihu |
| | | fermented | | |
| G3 | Green tea | Non- | Teekanne | China |
| | | fermented | | |
| G4 | Green tea | Non- | Meβmer | China |
| | | fermented | | |
| G5 | Green tea | Non- | Linglong | Hunan Guidong |
| | | fermented | | |
| G6 | Green tea | Non- | Biluochun | Jiangsu |
| | | fermented | | Dongting |
| O1 ^{b} | Oolong tea | Semi- | Tieguanyin | Fujian Anxi |
| | | fermented | | |
| O2 ^{b} | Oolong tea | Semi- | Tieguanyin | Fujian Anxi |
| | | fermented | | |
| O3 | Oolong tea | Semi- | Huangguanyin | Fujian Wuyishan |
| | | fermented | | |
| O4 | Oolong tea | Semi- | Tieluohan | Fujian Wuyishan |
| | | fermented | | |
| O5 ^{b} | Oolong tea | Semi- | Rougui | Fujian Wuyishan |
| | | fermented | | |
| O6 ^{b} | Oolong tea | Semi- | Rougui | Fujian Wuyishan |
| | | fermented | | |
| O7 | Oolong tea | Semi- | Shuixian | Fujian Wuyishan |
| | | fermented | | |
| O8 ^{b} | Oolong tea | Semi- | Rougui | Fujian Wuyishan |
| | | fermented | | |

^{a} Earl grey.
^{b} Tea samples (G1, G2; O1, O2 and O5, O6, O8) were obtained from different manufacturers in China.

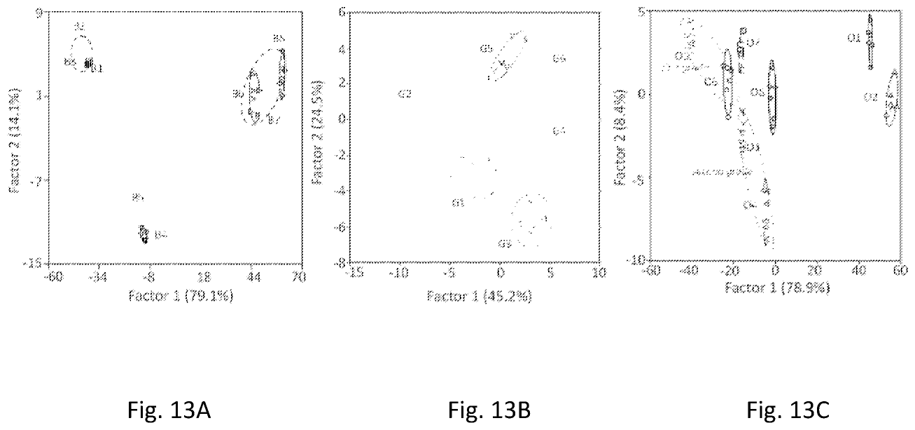

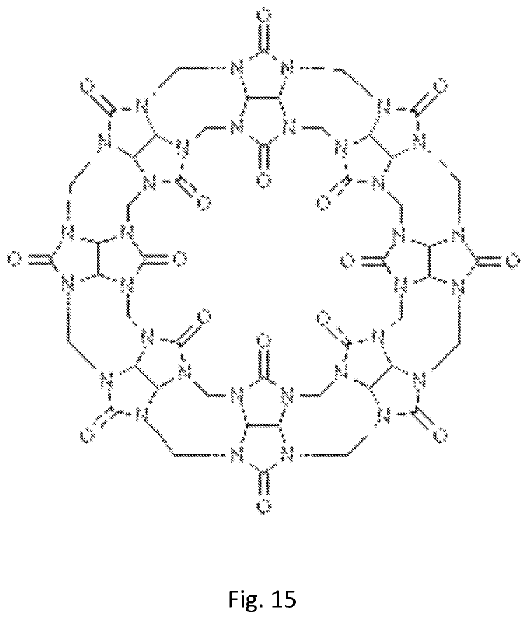

FIGS. 13A-13C show the identification of different black teas (FIG. 13A), green teas (FIG. 13B), and oolong teas (FIG. 13C) using a 6-element tongue of PPEs complexed with curcurbit[8]uril (C8). In this case, C8 forms a complex with two PPE-molecules and this complex is reduced in its fluorescence. The addition of C8 makes the system more sensitive and increases the discriminative power of the PPE-tongue. The structure of C8 is shown in FIG. 15.

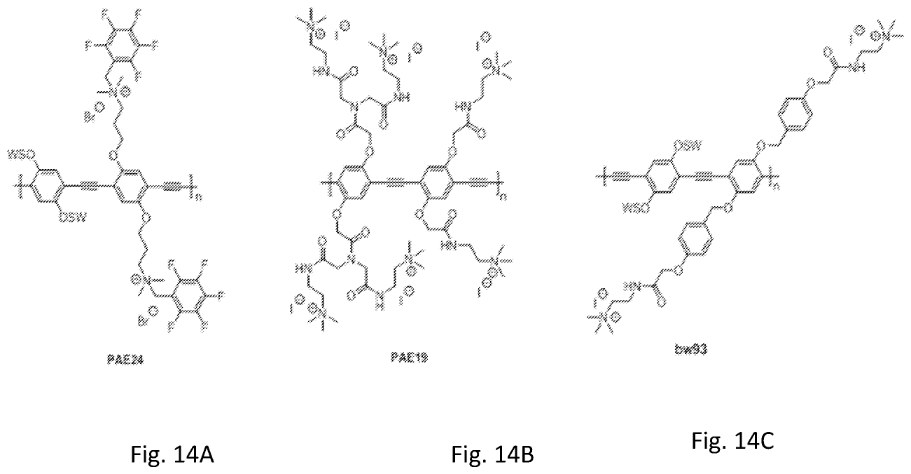

It was that, after exposure to the six element tongue, in which we combined three different PPEs shown in FIG. 14A-14C with curcurbit[8]uril (C8) at two different pH values (pH 3 and pH13), it was possible to obtain a data set which upon linear discriminant analysis discriminated all of the different teas according to character, type and brand. We could (see Table 5) identify 84% of all tested unknown samples of black teas and 100% of green and oolong teas.

TABLE 5
Jackknifed classification matrix and unknown sample
identification obtained from LDA

| Tea samples | | black tea | green tea | oolong tea |
|---|---|---|---|---|
| Jackknifed | Number of samples | 48 | 36 | 48 |
| classification | Correctly classified | 45 | 36 | 48 |
| matrix | Accuracy (%) | 94 | 100 | 100 |
| Unknown | Number of samples | 32 | 24 | 32 |
| samples | Correctly classified | 27 | 24 | 32 |
| identification | Accuracy (%) | 84 | 100 | 100 |

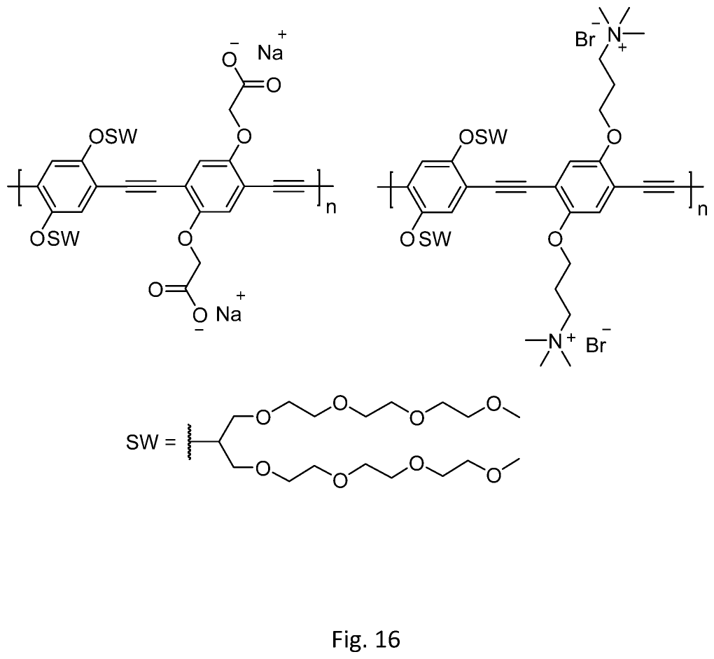

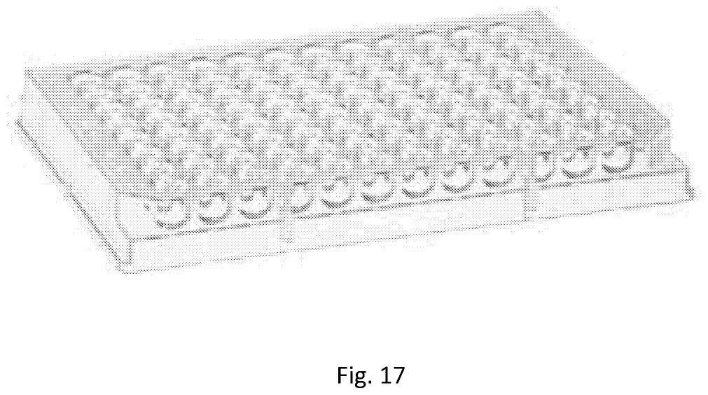

A further application is the discrimination of red wines which can be analyzed through a sensor array that is very similar to that employed for the identification of the white wines. Fourteen different red wines were tested and discriminated using the tongue already employed for the white wine discrimination, as shown in the table 6 below. First experiments also suggest that we can discriminate Amarone wines from Ripasso wines and Barolo types using the PPEs shown in FIG. 16

| | | | | | | | | Resid. | | | |
|---|---|---|---|---|---|---|---|---|---|---|---|
| | | | | | | | Acids | sugar | | | vol. |
| Ref. | Vintage | Varietal | % | Brand | Sugar | Origin | (g/l) | (g/l) | Grape 2 | (%) | (%) |
| Blau | 2013 | Blaufränkisch | 100 | Weingut Heinz | | Germany | 6.1 | 15.5 | | | 11.5 |
| | | (Lemberger) | | Pfaffmann - | | | | | | | |
| | | | | Lemberger feinherb | | | | | | | |
| Bordeaux | 2014 | Bordeaux | 80 | Chai de Bordes | | France | | | Cabernet | 20 | 13 |
| | | grape 1: Merlot | | Rouge - Cheval | | | | | Sauvignon | | |
| | | | | Quancard Bordeaux | | | | | | | |
| CaSa | 2015 | Cabernet | 100 | Grand Verdier | | France | | | | | 13 |
| | | Sauvignon | | Cabernet | | | | | | | |
| | | | | Sauvignon | | | | | | | |
| Dorn1 | 2015 | Dornfelder | 100 | Adam Müller - | Dry | Germany | 5.2 | 2.8 | | | 12.5 |
| | | | | Dornfelder QbA | | | | | | | |
| | | | | trocken | | | | | | | |
| Dorn2 | 2015 | Dornfelder | 100 | Edenkobener | Semidry | Germany | 4.4 | 9.1 | | | 12.5 |
| | | | | Schloss | | | | | | | |
| | | | | Ludwigshöhe - | | | | | | | |
| | | | | Dornfelder | | | | | | | |
| Merlot | 2015 | Merlot | 100 | Cavit Trento - | | Italy | | | | | 12.5 |
| | | | | Mastri Vernacoli - | | | | | | | |
| | | | | Cantina Viticoltori | | | | | | | |
| | | | | Trentino | | | | | | | |
| Nebiolo | 2012 | Nebbiollo | 100 | Conte Maresco | Dry | Italy | | | | | 13.5 |
| | | | | Barolo | | | | | | | |
| PiMe1 | 2014 | Pinot Meunier | 100 | Adam Müller - | Dry | Germany | | | | | 12 |
| | | (Schwarzriesling) | | Sulzfelder | | | | | | | |
| | | | | Lerchenberg | | | | | | | |
| | | | | Schwarzriesling | | | | | | | |
| | | | | Kabinett trocken | | | | | | | |
| PiMe2 | 2015 | Pinot Meunier | 100 | Kürnbacher | Semidry | Germany | | | | | 12.5 |
| | | (Schwarzriesling) | | Stiftsberg | | | | | | | |
| | | | | Schwarzriesling | | | | | | | |
| PiNo1 | 2014 | Pinot Noir | 100 | Edenkobener | Dry | Germany | 5.4 | 4 | | | 12.5 |
| | | (Späatbugunder) | | Schloss | | | | | | | |
| | | | | Ludwigshöhe | | | | | | | |
| | | | | Späburgunder | | | | | | | |
| | | | | trocken | | | | | | | |
| PiNo2 | 2014 | Pinot Noir | 100 | Weingut Heinz | Dry | Germany | | | | | 13 |
| | | (Späatbugunder) | | Pfaffmann | | | | | | | |
| | | | | Spätburgunder | | | | | | | |
| | | | | trocken | | | | | | | |
| Samtrot | 2014 | Samtrot | 100 | Lauffener | | Germany | 4.3 | 16.1 | | | 10.5 |
| | | (mutation of | | Katzenbeißer | | | | | | | |
| | | Pinot Meunier/ | | Samtrot Kabinett | | | | | | | |
| | | Schwarzriesling) | | | | | | | | | |
| Syrah | 2014 | Syrah (Shiraz) | 100 | Kangaroo Ridge - | | Australia | | | | | 13.5 |
| | | | | Shiraz | | | | | | | |
| Zinfandel | 2015 | Zinfandel | 100 | Farnese Vini | Dry | Italy | | | | | 13.5 |
| | | (Primitivo) | | Farneto Valley | | | | | | | |
| | | | | Primitivo IGP | | | | | | | |
| | | | | Puglia | | | | | | | |

In a further aspect, the method and sensor array can be used to verify the authenticity of products. This involves extracting a small portion of the product and dissolving this small portion in, for example, water or alcohol to form a solution. The solution will be applied to the sensor array and the fluorescence response measured. The fluorescence response can be compared against the expected fluorescence response for genuine materials.

This method enables a manufacturer of a product to send, for example, a vial of a reference solution of the product to a testing laboratory so that the testing laboratory has a standard against which products can be tested. In a further aspect, the reference solution is dried on a substrate before being sent from the manufacturer to the testing laboratory. The dry product can then be made up again into a reference solution at the testing laboratory In a further aspect, the method and sensor array can be used as a marker for genuine articles. The solution is place on part of the article at a known position and allowed to dry. The position is known and the testing laboratory can at a later stage remove part of the dried solution for testing. Examples of marked products include, but are not limited to, high value watches.

1. A method for identification of an analyte comprising:
preparing a plurality of solutions at a plurality of pH values of at least one fluorescent poly(para-phenyleneethynylene) and its complex;
exposing the complex analyte to the plurality of the solutions;
measuring the fluorescence intensity of the exposed complex analyte;
comparing the fluorescence intensity with a library; and
identifying the complex analyte from the comparison.

2. The method of claim 1, wherein the analyte is at least one of a fruit juice or an active pharmaceutical preparation.

3. The method of claim 1, wherein the poly(para-phenyleneethynylene) is selected from one of the poly(para-phenyleneethynylene)s shown in FIG. 2, 3 or FIG. 8.

4. A sensor array for the identification of an analyte comprising:
a plurality of wells having solutions at a plurality of pH values of at least one fluorescent poly(para-phenyleneethynylene) and its complex;
an excitation light source;
a fluorescent light detector; and
a storage device for recording a plurality of fluorescent light patterns.

5. The sensor array of claim 4, further comprising a processor adapted to accept measured fluorescent light intensity from the fluorescent light detector and compare the measured fluorescent light intensity with the plurality of stored fluorescent light patterns.

6. The sensor array of claim 4, wherein the poly(para-phenyleneethynylene) is selected from one of the poly(para-phenyleneethynylene shown in FIG. 2B, 3A, 3B, 3C or FIG. 8B.
